(19) United States
(12) Patent Application Publication
(10) Pub. No.: US 2012/0015178 A1
(43) Pub. Date: Jan. 19, 2012

(54) EPOXY BASED COVERLAYS AND METHODS AND COMPOSITIONS RELATING THERETO

(75) Inventor: Yukio Yada, Tochigi (JP)

(73) Assignee: E. I. DU PONT DE NEMOURS AND COMPANY, Wilmington, DE (US)

(21) Appl. No.: 12/985,378

(22) Filed: Jan. 6, 2011

Related U.S. Application Data
(60) Provisional application No. 61/294,860, filed on Jan. 14, 2010.

(51) Int. Cl. B32B 27/08

(52) U.S. Cl. 428/335; 428/355 EP

(57) ABSTRACT

A coverlay film, which is used for protection of a flexible printed circuit board, is provided by the invention as being imparted with improved adhesiveness, heat-resistance against molten solder alloy, punching workability and other properties. The inventive coverlay film is characterized by the novel and unique formulation of the adhesive to form an adhesive layer on one surface of a substrate plastic, e.g., polyimide, film. The adhesive is formulated with an epoxy resin, toughener, epoxy curing agent/curing accelerator polymer and a flame retardant, each of a specified type and in a specified weight proportion.

### FIELD OF THE INVENTION

The present disclosure relates generally to coverlays for protecting flexible circuits, comprising an epoxy based adhesive formulated to provide desired properties, particularly improved adhesion when subjected to a plating bath. More specifically, the epoxy based adhesives of the present disclosure are formulated with: i. a curing agent/curing accelerator polymer; and ii. a melamine functionalized, phosphorous based flame retardant.

### BACKGROUND OF THE INVENTION

Coverlay films are used to protect flexible printed circuit boards and generally consist of a protective layer, such as a polyimide film layer, and an adhesive layer. Various kinds of coverlay adhesives have been used, see for example, U.S. Pat. No. 5,260,130 to Sakaguchi, et al. Conventional coverlay adhesives tend to have advantages and disadvantages, and broadly speaking, none are able to fully satisfy all industry demands simultaneously. A need exists in the industry for an improved coverlay adhesive having a high level of heat resistance (e.g., solder resistance), peel strength (particularly when immersed in a plating bath), uniform flow, and confirmation performance.

### SUMMARY OF THE INVENTION

The present disclosure is directed to a coverlay film for the protection of a flexible circuit board. The coverlay film comprises a heat-resistant plastic film and a layer of an adhesive composition formed on one surface of the heat-resistant plastic film. The adhesive compositions of the present disclosure comprise, as a blend: (a) 100 parts by weight of an epoxy resin; (b) from 40 to 150 parts by weight of a toughener; (c) from 1 to 50 parts by weight of a curing agent/cure accelerator polymer; and (d) from 0.1 to 25 parts by weight of a melamine functionalized, phosphorous based flame retardant polymer.

### DETAILED DESCRIPTION OF THE PREFERRED EMBODIMENT(S)

### Overview

The coverlay compositions of the present disclosure include a heat resistant plastic film coated on one surface with an adhesive composition. The adhesive can be used to bond the heat resistant plastic film to a surface of a flexible circuit board, thereby protecting the performance (e.g., the structural integrity) of the circuit board, particularly when the flexible circuit board is bent and/or placed in a harsh environment.

### Heat Resistant Plastic Film

The coverlay's heat resistant plastic film can be any suitable material, including a polyimide, polyphenylene sulfide, poly(parabanic acid), heat-resistant polyester, poly(ether sulfone), polylether ether ketone (PEEK) or the like. In one embodiment, the heat resistant plastic film is a polyimide. In one embodiment, the heat resistant plastic film has a thickness in a range from 0.010 to 0.20 mm, and in another embodiment has a thickness of 0.013 to 0.125 mm. In some embodiments, the heat resistant plastic film has sufficient heat resistance to withstand soldering, using molten solder alloys at temperatures of at least about 200° C., 225° C., 250° C., 275° C., 300° C., 325° C., 350° C., 375° C. or 400° C.

### Adhesive Composition—Overview

The adhesive composition of the present disclosure is formed as a layer on one surface of the above mentioned heat-resistant plastic film. In one embodiment, the adhesive is formulated with at least four ingredients: 1. an epoxy resin component; 2. a toughener component; 3. a curing agent/cure accelerator polymer component; and 4. a flame retardant component.

### Adhesive Composition—Epoxy Resin Component

The first adhesive ingredient of the present disclosure is an epoxy resin, which can be any epoxy resin having at least two epoxy groups per molecule. Useful such epoxy resins include:

1. glycidyl ether type epoxies, such as, bisphenol A type epoxy resins and novolac resins,

2. alicyclic epoxy resins, and

3. aromatic epoxy resins.

The epoxy resins can be used either singularly or as a combination of two kinds or more. In one embodiment, one or more bisphenol A type epoxy resins are used as the first ingredient. In one embodiment, the epoxy resin is present in a range between (and optionally including) any two of the following weight percentages, based upon the total weight of the adhesive: 15, 18, 20, 22, 25, 27, 30, 32 35, 37, 40, 42, 45 and 50 weight percent.

### Adhesive Composition—Toughener Component

The second adhesive ingredient is a toughener. In one embodiment, the toughener is an elastomer. In one embodiment, the elastomer is an ethylene acryl rubber, available from E. I. du Pont de Nemours and Co., Wilmington, Del., USA under the trade name Vamac® G. In another embodiment, the toughener is a nitrile rubber having carboxyl groups, such as, a copolymeric rubber of acrylonitrile and butadiene carboxylated at the molecular chain ends. Commercial nitrile rubbers suitable as a toughener in accordance with the present disclosure include Hycars CTBN and CTBNX each produced by Goodrich Co., Nipols 1072J, 1072B, DN 612, DN 631 and DN 601 each produced by Nippon Zeon Co. and the like. The toughener can be used either singularly or as a combination of two kinds or more, according to any particular embodiment selected. In one embodiment, the carboxyl-containing nitrile rubber contains carboxyl groups in an amount from 2 to 8% by weight, based upon the total weight of the nitrile rubber.

In one embodiment, the toughener is present in a range between (and optionally including) any two of the following weight percentages, based upon the total weight of the adhesive: 20, 22, 25, 27, 30, 32 35, 37, 40, 42, 45, 47, 50, 52, 55, 57 and 60 weight percent. As the amount of toughener is decreased, peel resistance will tend to decrease, but as the amount of toughener increases, thermal stability will tend to decrease. Ordinary skill and experimentation may be necessary in selecting the proper loading of toughener, depending upon any particular application chosen.

### Adhesive Composition—Curing/Cure Accelerator Polymer Component

The third adhesive ingredient is a curing agent/cure accelerator polymer component, where a curing agent moiety and a cure accelerator moiety share a common polymer backbone or otherwise are functional groups on the same polymer. Any epoxy-curing moiety can be used without particular limitations, including:

1. amine moieties, such as, diamines, triamines or tetramines supported by a substituted or unsubstituted alkyl, aryl, or alkyl-aryl group;

2. acid anhydrides, such as, aliphatic, aromatic or aliphatic-aromatic anhydrides, including dianhydrides, trianhydrides and tetra anhydrides;

3. aliphatic, aromatic or aliphatic-aromatic cyanoamides;

4. aliphatic, aromatic or aliphatic-aromatic amine complexes; and

5. phenolic functional groups.

The above epoxy curing moieties can be used either singularly or as a combination of two kinds or more according to the desired application. In one embodiment, the curing agent moiety is a phenol.

The curing agent/cure accelerator polymer component of the adhesive also comprises a cure accelerator moiety, such as:

1. aliphatic, aromatic or aliphatic-aromatic imidazoles;

2. aliphatic, aromatic or aliphatic-aromatic tertiary amines; and

3. aliphatic, aromatic or aliphatic-aromatic metal borofluorides, such as, tin borofluoride, nickel borofluoride, and zinc borofluorides.

The above cure accelerator moieties can be used either singularly or as a combination of two kinds or more, according to the particular embodiment selected.

In one embodiment, the curing agent/cure accelerator polymer component comprises more than one phenol moiety and at least one triazine moiety, connected by a single backbone or otherwise being functional groups on the same polymer.

In one embodiment, the amount of the curing agent/cure accelerator polymer component in the adhesive composition is in a range between, and optionally including, any two of the following: 0.5, 1, 2, 3, 4, 5, 7, 10, 12, 15, 18, 20, 22, 25, 27, 30 weight percent, based upon the total weight of the adhesive composition. The amount of curing agent/cure accelerator polymer component will generally depend upon the type of epoxy resin selected. When the amount thereof is too small, the adhesive may not become fully cured by heating so that the heat resistance and peel strength performance of the coverlay film would then generally be decreased. However, if the amount thereof is too large, the curing reaction of the adhesive may proceed so readily that the storability and/or shelf life of the coverlay film would be decreased and flowability and uniformity may also be decreased.

### Adhesive Composition—Flame Retardant Component

The flame retardant of the present disclosure comprises a melamine moiety and contains little, if any, halogen, i.e., the halogen content is less than 1000, 500, 250, 100, 50, 10 or 1 parts per million halogen. In one embodiment, the flame retardant component is halogen free. The flame retardant component further comprises two or more phosphorous based moieties. Examples of flame retardant components useful in accordance with the present disclosure include melamine polyphosphate (MPP), melamine pyrophosphate, and mixture thereof. In one embodiment, the flame retardant compound contains more than two phosphorous based functional groups in its molecular structure. In one embodiment, the amount of the flame retardant component is in a range between, and optionally including, any two of the following: 0.5, 1, 2, 3, 4, 5, 7, 10, 12, 15, 18, 20, 22, 25, 27, 30 weight percent, based upon the total weight of the adhesive composition.

### Adhesive Composition—Other Optional Components

The adhesives of the present disclosure can further comprise other optional ingredients, up to an amount of 20, 15, 12, 10, 8, 6, 5, 4, 3, 2, 1 or 0.5 weight percent based upon the total weight of the adhesive. In one embodiment, a filler is present, such as, an inorganic powder. Useful inorganic powders include magnesium hydroxide, silica, magnesium silicate hydroxide (talc), nano-clay, titanium dioxide, boron nitride (BN), and mixtures thereof.

The adhesives of the present disclosure can further comprise a coupling agent for improved adhesion, water resistance and heat resistance, when the adhesive is applied to a flexible circuit. Useful coupling agents include polymers comprising a silane functionality, such as, organo-silanes, for example, amino silanes.

### Adhesive+Heat Resistant Plastic Film

The adhesive composition of the present disclosure can be coated homogeneously upon the heat resistant plastic film. In one embodiment, the thickness of the adhesive coating is within a range of 5 to 50 microns. Such coating can be conducted in any one of a number of ways.

### EXAMPLES AND COMPARATIVE EXAMPLES

The following, examples and comparative examples are given to illustrate the coverlay films of the present disclosure in more detail but are not intended to limit the scope of the invention in any way.

The following materials and methods were used in the examples:
1. Epoxy resin
2. Toughener
3. Epoxy Cure/Cure Accelerator
4. Flame Retardant
5. Other Optional Ingredients
6. Formulation
7. Peeling Resistance (including peel resistance during and after plating bath immersion)
8. Heat resistance Against Molten Solder Alloy
9. Flame retardancy
10. Punching workability
11. Press-out of adhesive (flowability, uniformity, etc.)

What is claimed is:

1. A coverlay film for the protection of a flexible circuit board which comprises:
(A) a heat-resistant plastic film; and
(B) a layer of an adhesive composition formed on one surface of the heat-resistant plastic film, the adhesive composition comprising, as a blend:
(a) 100 parts by weight of an epoxy resin;
(b) from 40 to 150 parts by weight of a toughener;
(c) from 1 to 50 parts by weight of a curing agent/cure accelerator polymer; and
(d) from 0.1 to 25 parts by weight of a melamine functionalized, phosphorous based flame retardant.

2. The coverlay film as claimed in claim 1 in which the layer of the adhesive has a thickness in a range from 10 to 60 microns and the curing agent/cure accelerator polymer comprises more than one phenol functional group and at least one triazine functional group per polymer.

3. The coverlay film as claimed in claim 1 in which the heat-resistant plastic film is a polyimide film.
